(19) United States
(12) Patent Application Publication
(10) Pub. No.: US 2021/0125196 A1
(43) Pub. Date: Apr. 29, 2021

(54) INFORMATION ANALYSIS DEVICE AND INFORMATION ANALYSIS METHOD

(71) Applicant: HONDA MOTOR CO., LTD., Tokyo (JP)

(72) Inventors: Yoshiaki Sugimoto, Tokyo (JP); Tadashi Kurihara, Tokyo (JP); Minoru Fukumori, Tokyo (JP)

(21) Appl. No.: 17/044,154

(22) PCT Filed: Feb. 19, 2019
(86) PCT No.: PCT/JP2019/006020

§ 371 Date: Sep. 30, 2020

(30) Foreign Application Priority Data
Apr. 3, 2018 (JP) 2018-071512

(51) Int. Cl. G06Q 30/02; G08G 1/065; H04W 4/029

(52) U.S. Cl. CPC G06Q 30/0201; H04W 4/029; G08G 1/065

(57) ABSTRACT

An information analysis device, provided with: a communication unit for receiving position information for a plurality of vehicles; a storage unit for storing map information including the positions of a plurality of facilities and customer visit data for customer visits to at least one or more facilities from among the plurality of facilities; a moving body visit determining unit for storing moving body visit data for visits by the plurality of vehicles to the facility, on the basis of the map information and the position information for the plurality of vehicles; a moving body visit ratio calculation unit for calculating the moving body visit ratio, which is the ratio between the number of moving body visits and the number of customer visits, for the facility; and a customer visit number calculation unit for calculating a hypothetical number of customer visits to the designated facility.

### TECHNICAL FIELD

The present invention relates to an information analysis device and an information analysis method which predict a customer visit number coming to another facility from the vehicle number coming to the other facility by vehicle, based on a proportion of the vehicle number coming to a certain facility and a customer visit number coming to this facility.

### BACKGROUND ART

Conventionally, technology has been developed for determining store visits to a facility by vehicle in order to analyze the ability to attract customers of a facility such as a restaurant. For example, Patent Document 1 discloses technology for recognizing store visits by vehicle based on time data for turning OFF an engine. On the other hand, according to the known systems disclosed in Patent Document 2 or 3, for example, it is made so that a POS terminal, a camera installed at a facility such as a store, or the like collects customer data (hereinafter referred to as “customer visit data”) recording the day and time at which a customer enters this facility (hereinafter simply referred to as “customer entering time”), the day and time at which leaving this facility (hereinafter simply referred to as “customer leaving time”), and transaction information (for example, purchased goods and sales information thereof) carried out by the customer at this facility.

Patent Document 1: Japanese Unexamined Patent Application, Publication No. 2016-045949

Patent Document 2: Japanese Unexamined Patent Application, Publication No. 2016-206799

Patent Document 3: Japanese Unexamined Patent Application, Publication No. 2016-167172

### DISCLOSURE OF THE INVENTION

### Problems to be Solved by the Invention

However, when using the technology disclosed in Patent Document 1, although it is possible to calculate and estimate a vehicle number coming to another facility, it has not been possible to estimate the customer visit number coming to the other facility using other transportation other than vehicles, including by walking, bicycle or the like other than a vehicle.

The present invention has an object of providing an information analysis device and information analysis method which predict a customer visit number coming to another facility from the vehicle number coming to the other facility by vehicle, based on the vehicle number coming to a certain facility by vehicle and a customer visit number coming to this facility.

### Means for Solving the Problems

An information analysis device (for example, the information analysis device 30 described later) according to a first aspect of the present invention includes: a reception unit (for example, the “communication unit 33” described later) which receives positional information of a plurality of moving bodies (for example, the vehicle 60 described later); a map information storage unit (for example, the “storage unit 32” described later) which stores map information including roads on which the plurality of moving bodies can travel, and positions of a plurality of facilities (for example, the “facility 70” described later) to which the plurality of moving bodies can visit; a visit data storage unit (for example, the “storage unit 32” described later) which stores customer visit data related to visits of customers to at least any one facility (for example, the “facility 70a” described later) among the plurality of facilities; a moving body visit determination unit (for example, the “moving body visit determination unit 312” described later) which determines visits of the plurality of moving bodies to the facility based on positional information of the plurality of moving bodies and a position of the facility stored in the customer visit data, and stores moving body visit data of the plurality of moving bodies to the facility; a moving body visit ratio calculation unit (for example, the “moving body visit ratio calculation unit 313” described later) which calculates a moving body visit ratio which is a ratio of a moving body visit number and a customer visit number for the facility, according to a comparison between the customer visit data and the moving body visit data for the facility; and a customer visit number calculation unit (for example, the “customer visit number calculation unit 314” described later) which, in a case of a facility (for example, the “facility 70a” described later) stored in the customer visit data being present in a predetermined region set in advance corresponding to a designated facility (for example, the “facility 70b” described later) that was arbitrarily designated from among the plurality of facilities, or on a road which is the same as the designated facility, calculates a virtual customer visit number to the designated facility, based on a moving body visit ratio to the facility calculated by the moving body visit ratio calculation unit.

According to the above first aspect, it is possible to predict the customer visit number coming to another facility from the vehicle coming to the other facility by vehicle, based on the proportion of the vehicle number coming to a certain facility by vehicle and the customer visit number coming to this facility. By configuring in this way, in one's own store for which the facility visit data is known, for example, it is possible to calculate the moving body visit ratio, which is a ratio of moving body visit number and the customer visit number to one's own store based on information such as positional information of moving bodies, and relative to another store (for example, competitor) for which the customer visit data is unknown, it is possible to predict the customer visit number to the other store using the moving body visit ratio of one's own store, by calculating the moving body visit number to this other store based on the positional information of a plurality of moving bodies.

According to a second aspect of the present invention, in the information analysis device (for example, the information analysis device 30 described later) as described in the first aspect, it may be configured so that the customer visit data is stored for every predetermined time slot of one day, and the customer visit number calculation unit (for example, the “customer visit number calculation unit 314” described later) calculates the customer visit number visiting the designated facility (for example, the “facility 70b” described later) for every predetermined time slot of one day.

According to the above second aspect, for example, in the case of a phenomenon such as the moving body visit ratio visiting by moving body in time slots at night becoming lower, for example, in the case of one's own facility being a restaurant, detailed analysis, such as being due to the many customers ordering alcohol, becomes possible.

An information analysis method according to a third aspect of the present invention is an information analysis method performed by a computer (for example, the information analysis device 30 described later) equipped with a map information storage unit (for example, the “storage unit 32” described later) which stores map information including roads on which a plurality of moving bodies can travel, and positions of a plurality of facilities to which the plurality of moving bodies can visit, and a visit data storage unit (for example, the “storage unit 32” described later) which stores customer visit data related to visits of customers to at least any one facility among the plurality of facilities, the method including the steps of: receiving positional information of the plurality of moving bodies (for example, the vehicle 60 described later); determining visits of the plurality of moving bodies to the facility based on positional information of the plurality of moving bodies and the position of the facility stored in the customer visit data, and storing moving body visit data of the plurality of moving bodies to the facility; calculating a moving body visit ratio which is a ratio of a moving body visit number and a customer visit number to the facility, according to a comparison between the customer visit data and the moving body visit data of the facility; and calculating, in a case of a facility stored in the customer visit data being present in a predetermined region set in advance corresponding to a designated facility that was arbitrarily designated from among the plurality of facilities, or on a road which is the same as the designated facility, a virtual customer visit number to the designated facility, based on a moving body visit ratio to the facility calculated in the step of calculating a moving body visit ratio.

According to the method as described in the above third aspect, the same effects as the information analysis device of the first aspect are exerted.

### Effects of the Invention

According to the present invention, it is possible to provide an information analysis device and information analysis method which predict a customer visit number coming to another facility from the vehicle number coming to the other facility by vehicle, based on the vehicle number coming to a certain facility by vehicle and a customer visit number coming to this facility.

### BRIEF DESCRIPTION OF THE DRAWINGS

FIG. 1 is a block diagram showing the basic configuration of an overall information analysis system, which is an embodiment of the present invention;

FIG. 2 is a functional block diagram showing the functional configuration of an onboard navigation device according to an embodiment of the present invention;

FIG. 3 is a functional block diagram showing the functional configuration of a mobile terminal according to an embodiment of the present invention;

FIG. 4 is a functional block diagram showing the functional configuration of an information analysis device according to an embodiment of the present invention;

FIG. 5 is a view showing an example of a positional information database according to an embodiment of the present invention;

FIG. 6 is a functional block diagram showing the functional configuration of a user terminal according to an embodiment of the present invention;

FIG. 7 is a flowchart showing the basic operation during update processing of the positional information database according to an embodiment of the present invention;

FIG. 8A is a flowchart showing the basic operation of predicting a virtual customer visit number according to an embodiment of the present invention; and

FIG. 8B is a flowchart showing the basic operation of predicting a virtual customer visit number according to an embodiment of the present invention.

### PREFERRED MODE FOR CARRYING OUT THE INVENTION

Hereinafter, a preferred embodiment of an information analysis system of the present invention will be explained in detail while referencing the drawings.

### <Overall Configuration of Information Analysis System 1>

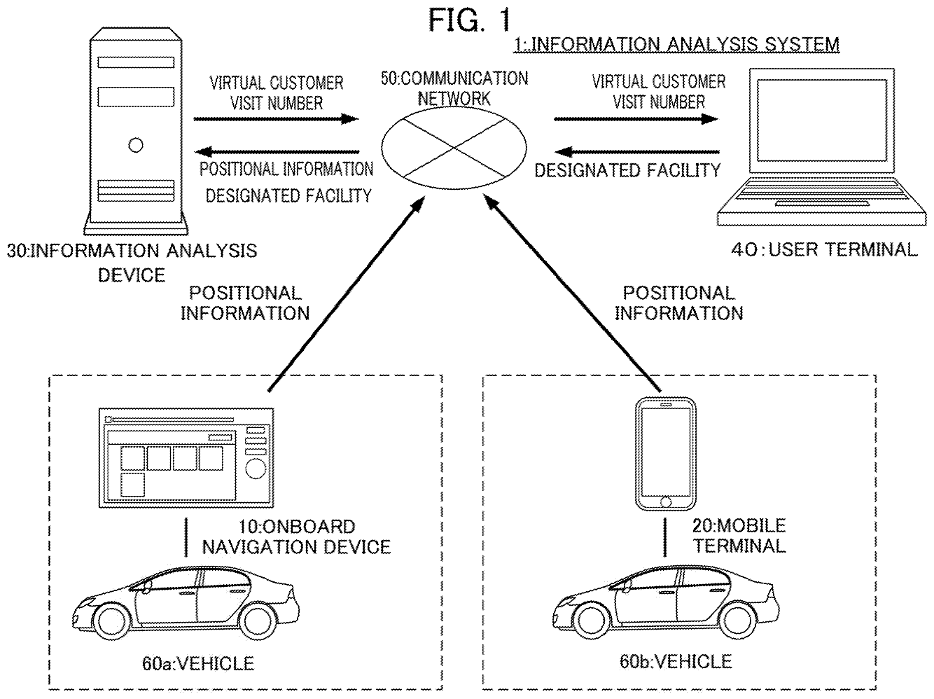

An information analysis system 1 according to a preferred embodiment of the present invention will be explained. FIG. 1 shows the overall configuration of the information analysis system 1.

As shown in FIG. 1, the information analysis system 1 is configured to include an onboard navigation device 10, mobile terminal 20, information analysis device 30, and user terminal 40. These respective devices and terminals are connected to be able to communicate with each other via a communication network 50. It should be noted that, in the drawings, although illustrating information transmitted between these respective devices and terminals, this information is only an example ultimately. In the present embodiment, information other than that illustrated may be transmitted.

The onboard navigation device 10 is a device which performs navigation (route guidance) to a user riding in a vehicle 60a. The onboard navigation device 10 performs route guidance from the current position until a destination, based on the request of a user. In addition, the onboard navigation device 10 also has a function of measuring the positional information (i.e. positional information of the vehicle 60a) of the onboard navigation device 10. The positional information measured by the onboard navigation device 10 is sent as appropriate to the information analysis device 30. The onboard navigation device 10 can be realized by a car navigation device installed in the vehicle 60a serving as the moving body, or a PND (Portable Navigation Device) which is easily installed in the vehicle 60a serving as the moving body and is portable.

The mobile terminal 20 is a mobile terminal used by a user riding in a vehicle 60b. The mobile terminal 20 has a function of measuring positional information of the mobile terminal 20 (i.e. positional information of the vehicle 60b), similarly to the aforementioned onboard navigation device 10. The positional information measured by the mobile terminal 20 is sent as appropriate to the information analysis device 30, similarly to the positional information measured by the onboard navigation device 10. The mobile terminal 20 can be realized by a smartphone, mobile phone, tablet terminal, notebook computer or other mobile electronic device.

It should be noted that, although the drawings illustrate the group of the onboard navigation device 10 and vehicle 60a and the group of the mobile terminal 20 and vehicle 60b as pairs, respectively, the number of these groups is not particularly limited. In addition, in the following explanation, in the case of explaining the vehicle 60a to which the onboard navigation device 10 is mounted, or the vehicle 60b in which the user using the mobile terminal 20 is riding without distinguishing therebetween, the Latin character suffix is omitted, and is simply called “vehicle 60”.

The information analysis device 30 is a device which performs analysis based on various information such as positional information, etc. of each vehicle 60 serving as a moving body, as unique processing of the present embodiment. More specifically, the information analysis device 30 acquires positional information of each vehicle 60, from the onboard navigation device 10 and mobile terminal 20, thereby creating a positional information database which is a database for positional information of each vehicle 60. Furthermore, the information analysis device 30 stores map information including the positions of the roads on which each vehicle 60 can travel, and the position of a plurality of facilities to which each vehicle 60 can visit.

Then, the information analysis device 30 calculates moving body visit data related to the moving body entering time and/or moving body leaving time of each of the plurality of vehicles 60 to the facility 70a, by calculating the day and time (hereinafter referred to simply as “moving body entering time”) at which each vehicle 60 enters the facility 70a (parking lot of facility) such as a store, and the day and time at which leaving this facility 70a (parking lot of facility), based on the positional information of each vehicle 60 and the map information. On the other hand, in the case of the facility 70a such as a store collecting customer visit data including the customer entering time, customer leaving time, etc. as mentioned above, the information analysis device 30 can store in advance in a storage unit the customer visit data of this facility 70a. The information analysis device 30 can calculate the moving body visit ratio which is the ratio of the moving body visit number and the customer visit number to the facility 70a, by comparison between the customer visit data and the moving body visit data of the facility 70a. In addition, the information analysis device 30 can calculate the moving body visit ratio which is the ratio of the moving body visit number and the customer visit number for every predetermined time slot of one day. It is thereby possible to analyze an aspect of the facility 70a from moving body visit ratios by time-slot. For example, in the case of the facility 70a being a dining bar, it is assumed that the moving body visit ratio drops at the time slots of night. Conversely, by statistically analyzing an aspect of a facility for which the moving body visit ratio drops at the time slots of night, it becomes possible to estimate an aspect of the facility of which the moving body visit ratio at night drops. In addition, by calculating the moving body visit ratio at different time slots and days of the week, for example, it become possible to conduct more detailed analysis of an aspect of the facility for which the moving body visit ratio is the same pattern. By configuring in this way, the information analysis device 30 can calculate the moving body visit ratio for different times of day (or different times of day and days of the week), for example, in the facility 70a having customer visit data. On the other hand, the information analysis device 30 is able to calculate the moving body visit number by FCD (Floating Car Data) for a facility competing with the facility 70a (competitor shop), facility with similar business conditions, or the like. When configuring in this way, the information analysis device 30 becomes able to estimate, under predetermined conditions, the customer visit number (also referred to as “virtual customer visit number”) to a facility competing with the facility 70a (competitor shop), facility with similar business conditions, or the like, based on the moving body visit ratio of the facility 70a. Herein, as the predetermined condition, it is possible to exemplify the matter of the facility competing with the facility 70a (competitor shop) or facility with similar business conditions being located on the same road as the facility 70a, or being located in a predetermined region satisfying a condition set in advance relative to the facility 70a. Based on the proportion of vehicle number coming to a certain facility by vehicle and a customer visit number coming to this facility (moving body visit ratio), it is possible to estimate the customer visit number coming to another facility from the vehicle number coming to the other facility by vehicle.

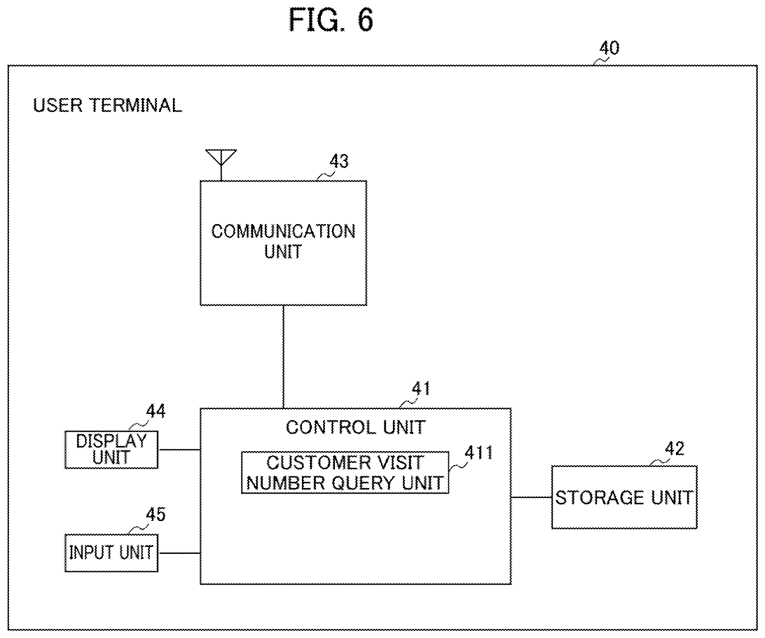

Since the user terminal 40 can be realized by a general personal computer, a detailed explanation will be omitted. As shown in FIG. 6, the user terminal 40 is configured to at least include a control unit 41, storage unit 42, communication unit 43, display unit 44 and input unit 45. The configuration of each part, for example, is respectively similar to the configuration of each part having the same name of the onboard navigation device 10 or mobile terminal 20.

The control unit 41 includes a customer visit number query unit 411. The customer visit number query unit 411 enables access by user ID assigned to person having authority to reference customer data of the facility 70a, for example, to the information analysis device 30. The customer visit number query unit 411 can query the (estimated) customer visit number of another facility for different time slots (or different time slots and days of the week), for example, by requesting calculation of the (estimated) customer visit number of the other facility to the information analysis device 30. By configuring in this way, it is made easy for the user to plan a partnership with another facility or sales promotional activities (campaigns) with visitors to the other facility as a target, for example, so that the customers visiting another facility will visit this facility, for example.

The user terminal 40 is a terminal which is manipulated by the user who is a manager of the facility 70a, for example, for analyzing the customer visit number visiting the other facility, based on the moving body visit ratio of the facility 70a. In order to obtain the (estimated) customer visit number (estimation) to the other facility, search conditions are inputted to the user terminal 40. The user terminal 40 transmits the search conditions thus inputted to the information analysis device 30. The information analysis device 30 calculates the (estimated) customer visit number to the other facility corresponding to the receiving search conditions, and replies to the user terminal 40.

The aforementioned information analysis device 30 and/or user terminal 40, for example, can be realized by incorporating software for realizing the present embodiment into a server device or personal computer.

The communication network 50 is realized by a network such as the Internet or mobile phone network, or a network combining these. In addition, a LAN (Local Area Network) may be included in part of the network (for example, between the information analysis device 30 and user terminal 40).

The vehicle 60 is a moving body in which the user of the onboard navigation device 10 or mobile terminal 20 rides. The vehicle 60, for example, is realized by a four-wheeled automobile, two-wheeled automobile, or the like.

### <Functional Blocks Equipped to Onboard Navigation Device 10>

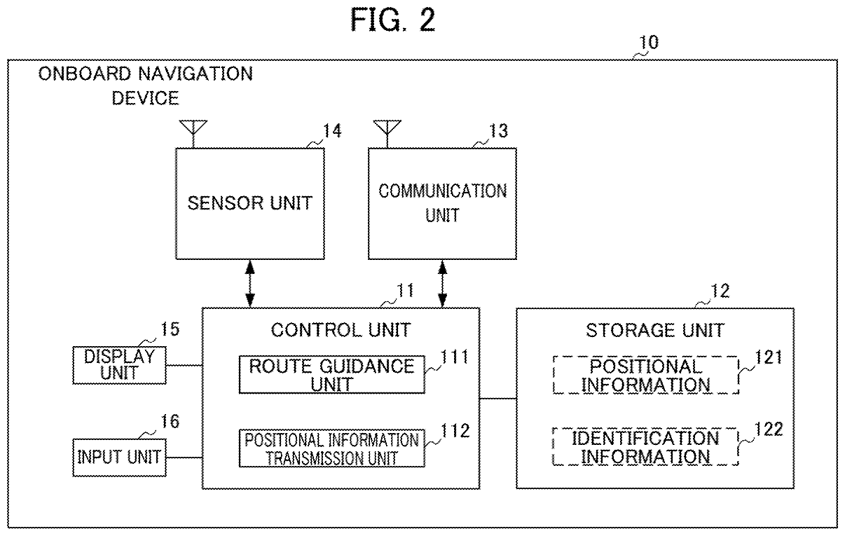

Next, the functional blocks equipped to the onboard navigation device 10 will be explained by referencing the block diagram of FIG. 2. Herein, the onboard navigation device 10 receives the supply of electrical power from the vehicle 60a, and automatically starts up by the ignition switch of the vehicle 60a being turned ON (starting engine) by the user riding in the vehicle 60a. Then, the onboard navigation device 10 operates until the ignition switch of the vehicle 60a is turned OFF (stopping engine) by the user riding in the vehicle 60a.

As shown in FIG. 2, the onboard navigation device 10 is configured to include a control unit 11, storage unit 12, communication unit 13, sensor unit 14, display unit 15 and input unit 16.

The control unit 11 is configured from an arithmetic processing device such as a microprocessor, and performs control of each part constituting the onboard navigation device 10. The details of the control unit 11 will be described later.

The storage unit 12 is configured by semiconductor memory or the like, and each of the programs such as a program for control called firmware or an operating system, program for performing route guidance processing, and program for performing transmission processing of positional information in the information analysis device 30, and other than this, various information such as map information including information related to features of roads, facilities, etc., road information, facility positional information, parking information, etc. are stored therein. The drawing shows positional information 121 and identification information 122, which are information particularly related to transmission processing of positional information, as information stored by the storage unit 12.

The positional information 121 is positional information (i.e. positional information of the vehicle 60a) of the onboard navigation device 10 measured by the sensor unit 14 described later. The positional information 121 is configured not only as information indicating the measured position, but also includes the time at which conducting measurement. In addition, the moving body identification information 122 is information for identifying the onboard navigation device 10. As the identification information 122, it is possible to employ a serial number or the like uniquely assigned to the onboard navigation device 10, for example. In addition, in order for the communication unit 13 to connect to a communication network 50, which is a network such as a mobile phone network, it is possible to use the telephone number assigned to the SIM (Subscriber Identity Module) inserted in the communication unit 13 as the identification information 122. In addition, it is possible to use the VIN (vehicle identification number) uniquely assigned to the vehicle 60a or number of the number plate as the identification information 122.

The communication unit 13 has a DSP (Digital Signal Processor), etc., and realizes wireless communication with other devices (for example, the information analysis device 30) via the communication network 50, according to a standard such as 3G (3^{rd} Generation), LTE (Long Term Evolution), or Wi-Fi (registered trademark). The communication unit 13, for example, is used in order for the positional information transmission unit 112 described later to transfer the positional information 121 and identification information 122 stored in the storage unit 12 to the information analysis device 30. However, there is no particular limitation in the data transmitted between the communication unit 13 and other devices, and may be configured so that information other than the positional information 121 and identification information 122 is transmitted.

The sensor unit 14 is configured by a GPS (Global Positioning System) sensor, gyro sensor, acceleration sensor, etc. The sensor unit 14 includes a function as a position detection means for detecting positional information, receives a GPS satellite signal by the GPS sensor, and measures the positional information (latitude and longitude) of the onboard navigation device 10. Positioning by the sensor unit 14 is performed at a predetermined time interval (for example, 3 second interval) as mentioned above. The measured positional information is stored in the storage unit 12 as positional information 121.

It should be noted that the sensor unit 14 is able to further raise the positioning accuracy of positional information of the onboard navigation device 10 based on the angular speed and acceleration measured by the gyro sensor and acceleration sensor. In addition, the sensor unit 14, in the case of GPS communication being difficult or impossible, uses AGPS (Assisted Global Positioning System) communication, and is also able to calculate the positional information of the onboard navigation device 10 by base station information acquired from the communication unit 13. It should be noted that the sensor unit 14 is not limited to a configuration including all of the aforementioned sensors. For example, the aforementioned sensor may be configured so that a part or the entirety thereof is included in an onboard sensor (not illustrated) equipped to the vehicle 60a. In this case, the control unit 11 may be configured so as to receive signals from the onboard sensor, or may be configured so as to receive information detected by the onboard sensor from an ECU (Electronic Control Unit) of the vehicle 60a.

The display unit 15 is configured by a liquid crystal display, or a display such as an organic electroluminescence panel. The display unit 15 receives instructions from the control unit 11, and displays an image. As information displayed by the display unit 15, for example, the current position of the onboard navigation device 10, map information of the vicinity of the current position of the onboard navigation device 10 read out from the map information, destination set by the user, meeting information notified from another onboard navigation device 10, route information, various user interfaces, etc. can be exemplified.

The input unit 16 is configured by an input device (omitted from illustration) such as physical switches called the numerical keypad, or a touch panel provided over the display surface of the display unit 15. By outputting to the control unit 11 a signal based on manipulation input from the input unit 16, for example, depression of the numerical keypad by a user, or touch of the touch panel, it is possible to realize a selection manipulation by the user, and manipulation such as scaling of the map.

It should be noted that, although not illustrated, it is also possible to include a speaker, microphone, etc. The speaker performs audio output to the driver, and the microphone collects the voice, etc. emitted by the driver. By configuring in this way, it is also possible to output information by sound from speakers, or input various selections, instructions by the driver audibly inputted via the microphone to the control unit 11 by voice recognition technology.

Next, an explanation will be made for the details of the control unit 11. The control unit 11 is configured by a microprocessor having a CPU (Central Processing Unit), RAM (Random access memory), ROM (Read Only Memory), I/O (Input/Output), etc. The CPU executes each program read out from the ROM or storage unit 12, and upon execution thereof, reads out information from the ROM and storage unit 12, performs writing of information in the RAM and storage unit 12, and performs transfer of signals with the communication unit 13, sensor unit 14, display unit 15 and input unit 16. Then, by configuring in this way, processing in the present embodiment is executed by the hardware and software (program) cooperating.

The control unit 11 includes a route guidance unit 111 and positional information transmission unit 112 as functional blocks.

The route guidance unit 111 is a portion which performs route guidance processing until a destination such as a facility inputted or selected by the user. The route guidance processing until the destination is equal to the route guidance processing of a general car navigation system. In other words, the route guidance unit 111 can perform route guidance by generating a map until the destination based on map information (omitted from illustration) stored in the storage unit 12, overlapping the current position of the onboard navigation device 10 measured by the sensor unit 14, the position of the destination, and the route information until the destination on this map, and displaying this on the display unit 15. In this case, it may be further configured so that the sound for route guidance is outputted from a speaker which is omitted from illustration. In addition, it may be configured so as to acquire information of the traffic status of roads, information of weather, etc. by communication from the communication unit 13, and use this acquired information in the route guidance processing. It should be noted that, since route guidance processing until a destination is well known to those skilled in the art, a detailed explanation more than this is omitted. In addition, since map information for performing route guidance processing is also well known to those skilled in the art, detailed explanation and illustration more than this is omitted.

The positional information transmission unit 112 is a portion which transmits positional information 121 and identification information 122 stored in the storage unit 12 to the information analysis device 30, by way of wireless communication using the communication unit 13. The transmission of the positional information 121 and identification information 122 to the information analysis device 30 by the positional information transmission unit 112 is performed periodically, from when the ignition switch of the vehicle 60a is turned ON (starting the engine) by the user riding in the vehicle 60a, the onboard navigation device 10 automatically starts, until the ignition switch of the vehicle 60a is turned OFF (stopping the engine). For example, every time the sensor unit 14 performs positioning at a predetermined time interval (for example, 3 second interval), transmission is performed in real time. In addition, it may be configured so as to transmit once collectively a plurality of units (for example, collecting identification information 122 and positional information 121 updated at 3 second intervals during 3 minutes) rather than transmitting to the information analysis device 30 in real time. In other words, it may be configured so as to do so-called burst transmission. Therefore, it can be arbitrarily set according to the environment, etc. in which applying the present embodiment, the length of the predetermined time interval, when to transmit in real time, or to do burst transmission.

By configuring in this way, the positional information transmission unit 112 transmits to the information analysis device 30 the identification information 122 and positional information 121 for specifying the movement route of the vehicle 60a positioned by the sensor unit 14, by performing real-time transmission or burst transmission.

In this case, for example, by the ignition switch being turned ON (starting engine) as in current engine cars, it is possible to transmit the position specified by the positional information 121 measured immediately after the onboard navigation device 10 automatically starts up as the initial vehicle position, i.e. departure position, to the information analysis device 30. In this case, the information analysis device 30 can define the time at which starting the reception of positional information 121 of the vehicle 60a as the leaving time from a facility (facility parking lot) where the vehicle 60a was staying. Furthermore, as in current engine cars, by the ignition switch being turned OFF (stopping engine), it is possible to transmit the position specified by the positional information 121 measured immediately before the onboard navigation device 10 was automatically stopped as the latest vehicle position, i.e. as the parking position, to the information analysis device 30. In this case, the information analysis device 30 can define the time at which stopping the reception of positional information 121 of the vehicle 60a as the entering time to the facility (facility parking lot) of the vehicle 60a. It should be noted that, the positional information 121 (i.e. parking position) measured immediately before the ignition switch was turned OFF (stopping engine) may be transmitted upon the ignition switch being turned ON (starting engine), and the onboard navigation device 10 automatically starting up.

In addition, even in a case of performing burst transmission, in the case of the vehicle 60a being determined as arriving at the destination (e.g., certain facility) by way of the route guidance unit 111, it is sufficient if the positional information transmission unit 112 switches so as to perform transmission in real-time. So long as configuring in this way, before the positional information 121 of the parking position is transmitted after arrival at a certain facility, it is possible to prevent a situation in which the ignition switch is turned OFF (engine stop), and the positional information 121 of the destination such as a facility not being transmitted to the information analysis device 30.

In addition, for vehicles for which transmission of positional information is possible even while stopped as in an electric vehicle (EV), the onboard navigation device 10 can transmit the vehicle stop signal information indicating that the vehicle has stopped. In this case, the positional information may be added to the vehicle stop signal information. By configuring in this way, the information analysis device 30 can define the time at which receiving the vehicle stop signal information of the vehicle 60a as the entering time to the facility of this vehicle 60a (facility parking lot), and define the positional information as the parking position. Furthermore, in the case of an electric vehicle, it is possible to transmit vehicle start signal information indicating the starting of the vehicle. In this case, the positional information may be added to the vehicle start signal information. By configuring in this way, the information analysis device 30 can define the time at which receiving the vehicle start signal information of the vehicle 60a as the leaving time from the facility (facility parking lot) of this vehicle 60a. It should be noted that it is preferable to set the flag indicating as being vehicle start signal information to 1 and transmit, and set the flag indicating as being vehicle stop signal information to 1 and transmit.

### <Functional Blocks Equipped to Mobile Terminal 20>

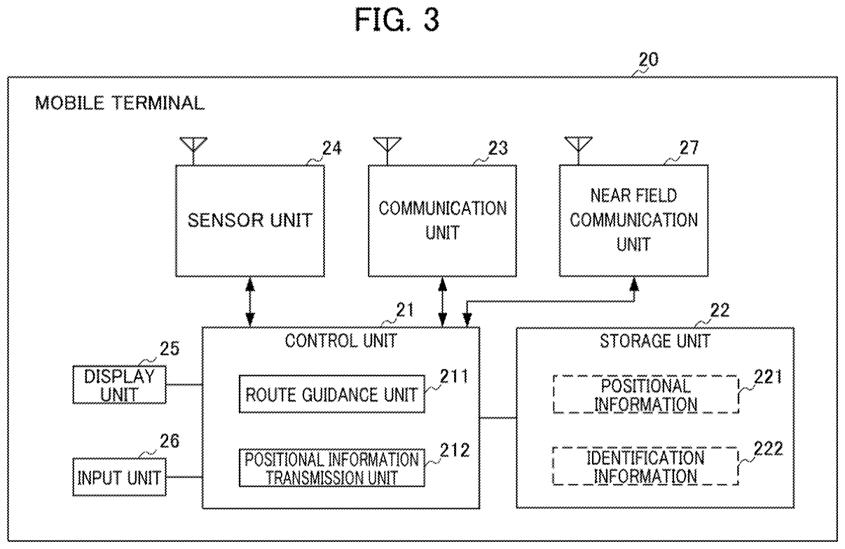

Next, an explanation will be made for the functional blocks equipped to the mobile terminal 20 by referencing the block diagram of FIG. 3. Herein, the aforementioned onboard navigation device 10 receives the supply of power from the vehicle 60a; however, the mobile terminal 20 receives the supply of power from a battery (omitted from illustration) equipped to itself. However, it may be configured so that the mobile terminal 20 receives the supply of power from a cigarette lighter socket of the vehicle 60b, etc. in order to charge the battery.

As shown in FIG. 3, the mobile terminal 20 is configured to include the control unit 21, storage unit 22, communication unit 23, sensor unit 24, display unit 25, input unit 26 and near field communication unit 27. Herein, the control unit 21, storage unit 22, communication unit 23, sensor unit 24, display unit 25 and input unit 26 have equivalent functions as the functional blocks of the same name included by the aforementioned onboard navigation device 10. In other words, by switching the wording of “onboard navigation device 10” with the wording of “mobile terminal 20” in the explanation of the aforementioned onboard navigation device 10, it becomes the explanation of each functional block of the mobile terminal 20; therefore, redundant explanations again will be omitted.

On the other hand, with regards to the mobile terminal 20, due to differing from the onboard navigation device 10 in the point including the near field communication unit 27, etc., the following explanation is made for this point of difference. The near field communication unit 27 is a portion for performing non-contact near field communication according to a standard such as NFC (Near Field Communication) or Bluetooth (registered trademark), or near field communication by wire via a USD (Universal Serial Bus) cable or the like. On the other hand, the vehicle 60b includes a near field communication unit for performing communication with a near field communication unit 27. For example, the ECU (Electronic Control Unit) of the vehicle 60b includes a near field communication unit. Then, a case of the mobile terminal 20 being able to communication by near field communication with the ECU is a case of the mobile terminal 20 existing inside of the vehicle 60b. In this case, the positional information measured by the sensor unit 24 of the mobile terminal 20 comes to correspond to the positional information of the vehicle 60b.

Therefore, the mobile terminal 20 causes the positional information transmission unit 212 to startup while near field communication with the ECU is possible via the near field communication unit 27. Then, the started positional information transmission unit 212 transmits to the information analysis device 30 the positional information 221 for specifying the movement route of the vehicle 60b positioned by the sensor unit 24, and the identification information 222, similarly to the positional information transmission unit 112 of the onboard navigation device 10.

For example, when the user gets into the vehicle 60b possessing the mobile terminal 20, and turns ON the start switch of the vehicle 60b such as the ignition switch, the vehicle 60b and mobile terminal 20 are connected (pairing), and the positional information 221 measured by the mobile terminal 20 and the moving body identification information 222 are transmitted from the mobile terminal 20 to the information analysis device 30. In this case, it is possible to transmit to the information analysis device 30 the position specified by the positional information 121 measured immediately after pairing of the vehicle 60b and mobile terminal 20 as an initial vehicle position, i.e. departure position. In addition, in the case of the startup switch of the vehicle 60b such as the ignition switch being turned ON, and the vehicle 60b and mobile terminal 20 being connected (pairing), the mobile terminal 20 can transmit the vehicle start signal information indicating starting the vehicle. In this case, the positional information may be added to the vehicle start signal information. By configuring in this way, the information analysis device 30 can define the time at which receiving the vehicle start signal information of the vehicle 60b as the leaving time from the facility (facility parking lot) of this vehicle 60b. In addition, in the case of the startup switch of the vehicle 60b such as the ignition switch being turned OFF, and the connection (pairing) between the vehicle 60 and mobile terminal 20 being released, the mobile terminal 20 can transmit the vehicle stop signal information indicating that the vehicle stopped. In this case, the positional information may be added to the vehicle stop signal information. By configuring in this way, the information analysis device 30 can define the time at which receiving the vehicle stop signal information of the vehicle 60b as the entering time to the facility (facility parking lot) of this vehicle 60b, and define the positional information as the parking position.

It should be noted that, as the timing at which the mobile terminal 20 transmits positional information to the information analysis device 30, it is similar to the positional information transmission unit 112 also in the point in that it may be transmitted in real time or may be burst transmission, the point in that burst transmission may be switched to transmission in real time in the case of determining as having arrived at the parking position, and the point in that vehicle startup signal information and vehicle stop signal information indicating the departure position or parking position in the aforementioned way may be added, and the point in that the parking position at the time of restarting may be transmitted.

It should be noted that, in the case of the vehicle 60b having a function of measuring positional information, it may be configured so as to transmit to the information analysis device 30 the positional information measured by the vehicle 60b, rather than the positional information measured by the sensor unit 24, as the positional information 121. In this case, it may be configured so as to omit the sensor unit 24 from the mobile terminal 20.

### <Functional Blocks Equipped to Information Analysis Device 30>

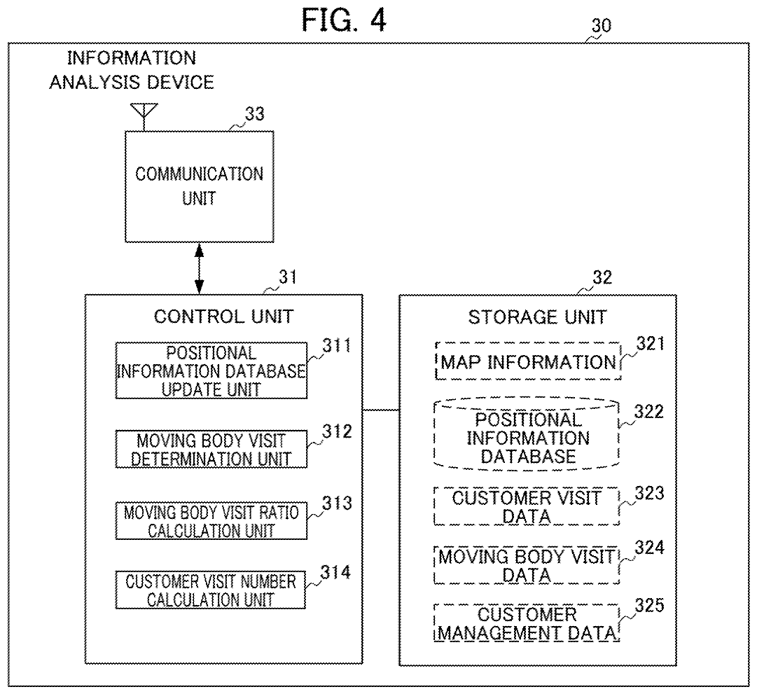

Next, an explanation will be made for the functional blocks equipped to the information analysis device 30 by referencing the block diagram of FIG. 4.

As shown in FIG. 4, the information analysis device 30 is configured to include a control unit 31, storage unit 32, and communication unit 33. It should be noted that, although not illustrated, it may include a display unit 35 and input unit 36.

The control unit 31 is configured from an arithmetic processing device such as a microprocessor, and performs control of each part constituting the information analysis device 30. The details of the control unit 31 will be described later.

The storage unit 32 is configured by semiconductor memory or the like, and stores each program such as a program for control called firmware or an operating system, and a program for performing information analysis processing, and further various information such as map information. The drawing illustrates map information 321 and a positional information database 322, customer visit data 323, moving body visit data 324 and customer management data 325, which are information particularly related to analysis processing of the positional information, as information stored by the storage unit 32.

The map information 321 includes information such as information related to features such as roads and facilities, road information, facility positional information and parking information. In addition, display map data for displaying the background such as roads and road maps; road network data which includes position information of nodes (for example, junctions of roads, inflection points, end points, etc.) and classification information thereof, position information of links which are routes coupling between each node and classification information thereof, link cost data related to cost information of all links (for example, distance, required time, etc.); and the like are included in the map information 321.

The position and shape of roads, and information of so-called road map such as the classification of roads, position of traffic lights, etc. are saved as road information. As the facility position information, the positional information of each facility is saved as information of longitude and latitude. In addition, additional information such as facility information related to the moving body identification information of a facility (already called “facility ID”), name, facility classification (and/or genre), telephone number, address, business hours, product service, etc. may be included as facility positional information. The positional information of parking is saved as information of longitude and latitude as parking information. In the case of the parking being parking of each facility, it is saved by associating the facility and parking.

The map information 321 may be established as a configuration stored in advance in the storage unit 32, or may be established as a configuration which is appropriately downloaded as needed from a server device (omitted from illustration) connected to the communication network 50. Furthermore, it may be appropriately modified according to the input of the user, etc.

The positional information database 322 is a database constructed based on the positional information 121, 221, and the identification information 122, 222 received from the onboard navigation device 10 and mobile terminal 20, respectively. The positional information database 322 is constructed from a positional information database update unit 311 described later. Details of the positional information database 322 are described later upon explanation of the positional information database update unit 311. It should be noted that, in the following explanation, upon explaining the positional information 121 and positional information 221 without distinguishing therebetween, they are called “positional information” by omitting the reference symbol. In addition, similarly, upon explaining without distinguishing between the identification information 122 and identification information 222, they are called “identification information” by omitting the reference symbol.

The customer visit data 323 is data related to customer visits to the facility 70a such as a store. More specifically, the customer visit data 323 includes data related to the entering time and/or leaving time of customers of the facility 70a. In addition, it may be configured so as to include transaction data of customers (goods or services purchased, for example, by a customer in this visit, the sales amount thereof, etc.). Herein, the facility is identified by facility identification information (facility ID), as mentioned above. In addition, a customer is identified by customer identification information (also referred to as “customer ID”) identifying the customer. Customer visit data 323 is stored individually for each facility 70a defined as a target of analysis. In other words, normally, the customer identification information (customer ID) is set individually for every facility 70a. Therefore, in the case of facilities 70a being different, the customer identification information (customer ID) is not necessarily the same in regards to the system of this identification information and value thereof. It should be noted that the creation method of the customer visit data, etc. are known to those skilled in the art as disclosed in Patent Document 2, Patent Document 3, etc. for example, and thus explanation thereof will be omitted. It should be noted that the customer visit data 323 is not limited to a case of storing in the storage unit 32 of the information analysis device 30. By configuring so as to store the customer visit data 323 in a server (not shown) managed by the facility 70a, it may be configured so as to be able to access the customer visit data 323 from the information analysis device 30 via the communication network 50 (or interface), for example.

The moving body visit data 324 is data related to moving body visits to the facility 70a such as a store. More specifically, the moving body visit data 324 includes data related to the entering time and/or leaving time of the moving body 60 (vehicle 60) to the facility 70a. Herein, the facility 70a is identified by the facility identification information (facility ID). In addition, the moving body 60 is identified by identification information (identification information 122 of the onboard navigation device 10 and identification information 222 of the mobile terminal 20) of the moving body (vehicle 60) as mentioned above.

The customer management data 325 may be configured so as to associate customer identification information (customer ID) for the facility 70a, and store in the storage unit 32, in the case of having individual profile information of this customer (for example, point card number of customer, historical information of points, electronic money information of customer, etc. It should be noted that the customer management data 325 is not limited to a case of storing in the storage unit 32 of the information analysis device 30. By configuring so as to store the customer management data in a server (not shown) managed by the facility 70a, it may be configured so as to be able to access the customer visit data 325 from the information analysis device 30 via the communication network 50 (or interface), for example.

The communication unit 33 has a DPS (Digital Signal Processor) or the like, and realizes wireless communication with other devices via the communication network 50, based on a communication standard such as 3G (3^{rd} Generation, LTE (Long Term Evolution), or Wi-Fi (registered trademark). The communication unit 33, for example, is used in order to receive the positional information and identification information transmitted from each of the onboard navigation device 10 and mobile terminal 20. In addition, the communication unit 33, for example, is used for receiving search conditions sent from the user terminal 40. Furthermore, the communication unit 33 is used for transmitting analysis information to the user terminal 40, for example. However, there are no particular limitations in the data transmitted between the communication unit 33 and other device, and may be configured so that information other than these types of information are transmitted.

Next, an explanation will be made for the details of the control unit 31. The control unit 31 is configured by a microprocessor having a CPU (Central Processing Unit), RAM (Random Access Memory), ROM (Read Only Memory), I/O (Input/Output), etc. The CPU executes each program read out from the ROM or storage unit 32, reads out information from the RAM, ROM and storage unit 32 upon execution thereof, performs writing of information in the RAM and storage unit 32, and performs transfer of signals with the communication unit 33, display unit 35 and input unit 36. Then, by configuration in this way, processing of the present embodiment is realized by the hardware and software (programs) cooperating.

The control unit 31 includes the positional information database update unit 311, moving body visit determination unit 312, moving body visit ratio calculation unit 313 and customer visit number calculation unit 314 as functional blocks.

### <Positional Information Database Update Unit 311>

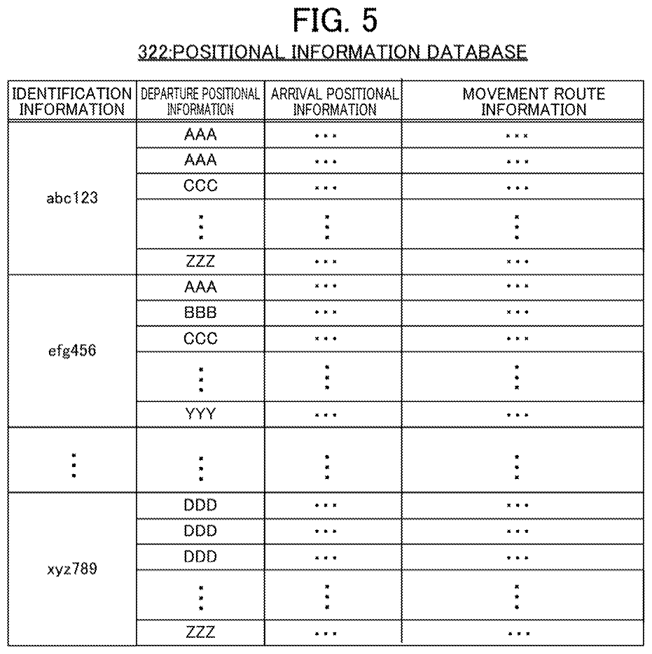

First, the positional information database update unit 311 will be explained. The positional information database update unit 311 is a portion which constructs the positional information database 322, as well as appropriately updates the positional information database 322. One example of the data structure of the positional information database 322 will be explained by referencing FIG. 5.

As shown in FIG. 5, the positional information database 322 includes “identification information” received from each of the onboard navigation device 10 and mobile terminal 20. Furthermore, the positional information database 322 creates and updates, in accordance with the movement sequence thereof, the travel history records defining the attributes of “departure positional information” including the “departure position” and “departure time”; “arrival positional information” including the “arrival position” and “arrival time”; and “movement route information” for every “identification information of vehicle 60” specified by the positional information database update unit 311, based on the “positional information” received from each of the onboard navigation device 10 and mobile terminal 20 by configuring in the above-mentioned. Herein, “departure positional information” in the travel history record is information for specifying the position from which the user departs by the vehicle 60 and the departure time. In addition, “arrival positional information” in the travel history record is information for specifying the position where the user arrived by the vehicle 60 and the arrival time.

More specifically, the positional information database update unit 311 receives the positional information, time information, etc. regularly transmitted until the ignition is turned OFF (i.e. from departure until arrival), and stores in the travel history record managed for every set of identification information of the vehicle 60. By configuring in this way, the travel history record stores information of the current position sequentially received from the vehicle 60. It should be noted that reception may be receiving once every several seconds, and may be configured so as to store in a time series manner on the vehicle 60 side, and collectively receive at a timing such as a fixed time or when starting an application on the side of the vehicle 60. In this case, the positional information database update unit 311 may define the position and time initially transmitted as departure positional information, when the vehicle 60 has the ignition turned ON.

The positional information database update unit 311 may determine the departure positional information and arrival positional information described above in the following way. With the vehicle 60, in the case of the transmission of positional information of the moving body (vehicle 60) stopping by the ignition being turned OFF as in the onboard navigation device 10 in current engine cars, for example, it may define the current position transmitted immediately before reception of positional information of the moving body (vehicle 60) stopped as the arrival position, and define the time at which reception of positional information stopped as the arrival time of the moving body. Similarly, in the case of the vehicle 60 starting transmission of positional information of the moving body (vehicle 60) by the ignition turning ON as in the onboard navigation device 10 in current engine cars, for example, it may define the current position at which starting reception of positional information of the moving body (vehicle 60) as the departure position, and define the time at which starting reception of the positional information as the departure time of the moving body.

In addition, in the case of the vehicle 60 being able to transmit moving body stop signal information even when the moving body stopped as in an electric vehicle, for example, it may define the time at which receiving the moving body stop signal as the arrival time of the moving body, and define the current position indicated by the moving body stop signal or the positional information closest to the positional information of the moving body as the arrival position. Similarly, in the case of the vehicle 60 being able to transmit moving body start signal information during startup of the moving body as in an electric vehicle, for example, it may define the time at which receiving the moving body start signal as the departure time of the moving body, and define the current position indicated by the moving body start signal as the departure position.

In addition, since driving of the moving body is continuous in the case of transmission of the positional information, etc. being started once, and then information indicating the arrival position still not being received, or a case of not being able to consider any position as the arrival position, the positional information database update unit 311 may store information such as “in motion”, for example, in the field of arrival position, due to still being in motion.

Furthermore, “route information” in the travel history record is all of the positional information received from when transmission of positional information, etc. is once started until ending. According to all of the positional information, it becomes possible to specify the movement route from the departure position unit the arrival position in drive units from ignition ON until ignition OFF. Next, the moving body visit determination unit 312 will be explained.

### <Moving Body Visit Determination Unit 312>

The moving body visit determination unit 312 determines a visit by a moving body to the facility 70 based on the travel history record of the positional information database 322, and extracts as moving body visit data. The moving body visit determination unit 312, based on the travel history record of the positional information database 322, creates moving body visit data 324 including the entrance time, which is the time at which the moving body (vehicle 60) enters the facility 70 such as a store, and a leaving time which is the time at which the moving body (vehicle 60) leaves. More specifically, the moving body visit determination unit 312 can determine whether the departure position or arrival position matches the facility position of the facility 70, by comparing the departure position and arrival position in the travel history record of each moving body, and the facility positional information of the facility 70 included in the map information 321 of the storage unit 32. It should be noted that it may be configured to arbitrarily decide the degree of “matching” between the aforementioned departure position or arrival position and the position of the facility 70. For example, in a case such that the onboard navigation device 10 or mobile terminal 20 can accurately measure positional information, it may be configured to narrow the range of determining as matching. On the other hand, in a case such that the onboard navigation device 10 or mobile terminal 20 cannot measure the positional information so accurately, it may be configured so as to widen the range of determining as matching. In other words, it may be configured so as to determine as matching in the case of the positions being slightly shifted.

In addition, the moving body visit determination unit 312 may determine the arrival time at the facility 70 of the moving body (vehicle 60) as the time (entering time) at which entering the facility 70, based on the travel history record of the positional information database 322. Similarly, the moving body facility determination unit 312 may determine the departure time of the facility 70 of the moving body (vehicle 60) as the time at which leaving the facility 70 (leaving time), based on the travel history record of the positional information database 322. In the above way, the moving body visit determination unit 312 can create for each facility 70 the moving body visit data 324 related to moving bodies 60 having visited this facility 70 within a predetermined period set in advance, for example, and store this in the storage unit 32. It should be noted that it is preferable for the moving body facility determination unit 312 to create in advance the moving body visit data 324 for each facility 70 included in the map information 321 of the storage unit 32, and store in the storage unit 32. By configuring in this way, the customer visit number calculation unit 314 described later can easily calculate a virtual customer visit number of a facility 70b for which customer visit data is not known, by applying the moving body visit ratio of a facility 70a satisfying predetermined conditions for which the customer visit data is known, as calculated by the moving body visit ratio calculation unit 313 described later. Next, the moving body visit ratio calculation unit 313 will be explained.

### <Moving Body Visit Ratio Calculation Unit 313>

The moving body visit ratio calculation unit 313, in the case of the customer visit data 323 for the facility 70a being known, calculates the moving body visit ratio, which is a ratio of the moving body visit number to the customer visit number for the facility 70a, according a comparison between the customer visit data 323 for the facility 70a and the moving body visit data 324 for the facility 70a. Hereinafter, to facilitate understanding, they will be distinguished by calling a facility for which the customer visit data 323 is known to a predetermined user as facility 70a, and calling a facility for which the customer visit data 323 is unknown to the predetermined user as facility 70b. It should be noted that, in the case of explaining without distinguishing between the two, they are simply called facility 70. When configuring in this way, the moving body visit ratio calculation unit 313 calculates the number of moving bodies having entered the facility 70a or number of moving bodies having left this facility in a predetermined time slot on a given day of the week, for example, based on the entering time to this facility 70a or leaving time from this facility 70a of the moving body (vehicle 60) included in the moving body visit data 324 for the facility 70a, in a predetermined period set in advance. It should be noted that, as the number of moving bodies having entered this facility 70a or left from this facility 70a in a time slot (for example, between 12 PM and 1 PM), on a given day of the week (for example, Sunday), the average value for the number of moving bodies having entered this facility 70a or left from this facility 70a in a predetermined time slot on a given day of the week within a predetermined period may be adopted, and the median value may be adopted. The calculation of the number of moving bodies having entered this facility 70a or left from this facility 70a in a predetermined time slot on a given day of the week can be decided arbitrarily.

For example, the predetermined period shall be three months, and the time slot from 12 PM to 1 PM on Sunday within this period shall be 12 times. Time slots of 12 times are identified by the index i (1≤i≤12), and the number Nᵢₙ(i) of moving bodies entering the facility 70a is defined in each time slot i, and the number Nₒᵤₜ(i) of moving bodies leaving the facility 70a is defined in each time slot i. It is possible to define the value obtained by dividing the total of Nᵢₙ(i) (1≤i≤12) by 12 as the entering number to the facility 70a of moving bodies in the time slot from 12 PM to 1 PM on Sunday, for example, and define the value obtained by dividing the total of Nₒᵤₜ(i) (1≤i≤12) by 12 as the leaving number from the facility 70a of moving bodies in the time slot from 12 PM to 1 PM on Sunday, for example. As mentioned above, it is not limited to the average value. For example, it may be configured to define the median value of set {Nᵢₙ(i):1≤i≤12} as the entering number to the facility 70a of moving bodies in the time slot from 12 PM to 1 PM on Sunday, and define the median value of set {Nₒᵤₜ(i):1≤i≤12} as the leaving number from the facility 70a of moving bodies in the time slot from 12 PM to 1 PM on Sunday.

In addition, in the aforementioned example, the entering number and leaving number of moving bodies in each time slot and day of the week was calculated; however, it is not to be limited to each day of the week. For example, it maybe calculate by time slots of holidays, days before holidays and weekdays. It can be arbitrarily decided. Hereinafter, the moving body entering number to the facility 70 and the moving body leaving number from the facility 70 are referred to as the moving body visit number of the facility 70.

Similarly, the moving body visit ratio calculation unit 313 calculates the customer entering number having entered this facility 70a or the customer leaving number having left this facility in a predetermined time slot on a given day of the week, for example, based on the entering time to this facility 70a of the customer or the leaving time from this facility 70a included in the customer visit data 323 of the facility 70a, within a predetermined period set in advance. It should be noted that a predetermined period, given day of the week and predetermined time slot use the same standard as during calculation of the visit number of moving bodies. In addition, the application of the average value, median value, etc. use the same standard as during calculation of the visit number of moving bodies. Hereinafter, the customer entering number having entered to the facility 70a or the customer leaving number having left the facility 70a is called the customer visit number of the facility 70a. By configuring in this way, the moving body visit ratio calculation unit 313, for example, can calculate the moving body entering ratio (=moving body entering number/customer entering number), which is a ratio of the number of moving bodies having entered the facility 70a in a predetermined time slot on a given day of the week, and the customer entering number having entered the facility 70a in the same time slot on the same day of the week. Similarly, the moving body visit ratio calculation unit 313, for example, can calculate the moving body leaving ratio (=moving body leaving number/customer leaving number) which is a ratio of the number of moving bodies having left from the facility 70a in a predetermined time slot on a given day of the week, and the customer leaving number having left from the facility 70a in the same time slot on the same day of the week. Hereinafter, the moving body entering ratio and the moving body leaving ratio are called moving body visit ratio. In this way, the moving body visit ratio calculation unit 313 can calculate the moving body visit ratio (moving body entering ratio and moving body leaving ratio), which is the ratio of the moving body visit number (moving body entering number and moving body leaving number) and the customer visit number (customer entering number and customer leaving number) for the facility 70a in a predetermined time slot on a given day of the week, for example, by way of comparison between the customer visit data 323 for the facility 70a and the moving body visit data for the facility 70a.

It should be noted that a difference in the movement time from the parking position until the facility entrance is assumed, for example, between the entering time (arrival time) to the facility 70 of the moving body (vehicle 60) in the moving body visit data, and the entering time to this facility 70 of the customer in the customer visit data. Similarly, a difference in the movement time from the facility exit to the parking position is assumed between the leaving time from this facility 70 of the customer, and the leaving time (departure time) from this facility 70 of the moving body (vehicle 60). For example, it may be configured so that the degree of “matching” between the entering time to the facility 70 of the moving body (vehicle 60) and the entering time to the facility 70 of the customer, degree of “matching” between the entering time to the facility 70 of the moving body (vehicle 60) and the entering time to this facility 70 of the customer, and the degree of “matching” between the leaving time from this facility 70a of the customer and the leaving time from this facility 70 of the moving body (vehicle 60) are arbitrarily decided. For example, in the case of the distance between the parking lot and entrance to the facility being short, it may be configured so as to narrow the range of determining as matching. On the other hand, in the case of the distance between the parking lot and entrance to the facility being long, it may be configured so as to widen the range of determining as matching.

The moving body visit ratio calculation unit 313 shall calculate in advance every predetermined time slot on a given day of the week, for example, the moving body visit ratio (moving body entrance ratio and moving body leaving ratio) for all of the facilities 70a (=facilities for which the customer visit data is known). In this way, for all of the facilities 70a, it is possible to analyze an aspect of the facility 70a based on the value of the moving body visit ratio by time slot, by calculating the moving body visit ratio, which is the ratio of the moving body visit number and the customer visit number for every predetermined time slot on a given day of the week.

Furthermore, it is preferable for the moving body visit ratio calculation unit 313 to calculate in advance the moving body visit number for all facilities 70b included in the map information 321 for every predetermined time slot on a given day of the week, and store in the storage unit 32, for example, based on the moving body visit data 324 created in advance for each facility 70b included in the map information 321 of the storage unit 32 by the moving body visit determination unit 312. By configuring in this way, the customer visit number calculation unit 314 described later can rapidly calculate the customer visit number for a designated facility 70b. Lastly, the customer visit number calculation unit 314 will be explained.

### <Customer Visit Number Calculation Unit 314>

The customer visit number calculation unit 314, in the case of any facility 70b (=facility 70b for which visiting customer data is not known to this user) being designated from the facilities 70 included in the map information 321 by the user, and in the case of the facility 70a for which the moving body visit ratio was calculated being present within a predetermined region satisfying a condition set in advance relative to this facility 70b (hereinafter also referred to as “designated facility”) or on the same road as the designated facility 70b, can calculate (predict) the customer visit number for the facility 70b in a predetermined time slot on a given day of the week, based on the moving body visit ratio of the facility 70a.

Herein, within a predetermined region satisfying a condition set in advance may be defined as an area within a predetermined range of distance centered around the position of the designated facility 70b, for example. In addition, as described later, it may be configured so as to display a map including the facility 70b on the display unit 44 of the user terminal 40, and so that the user designates the predetermined range on the displayed map. By configuring in this way, it is possible to set the optimum region according to the road conditions.

The customer visit number calculation unit 314 causes the moving body visit number for the facility 70b in every predetermined time slot on a given day of the week to be calculated in the moving body visit ratio calculation unit 313. It should be noted that, in the case of the moving body visit number for every predetermined time slot on a given day of the week being calculated in advance for all facilities 70b included in map information in advance, and being stored in the storage unit 32 as described above, the moving body visit number for every predetermined time slot on a given day of the week, for example, may be referenced for the designated facility 70b from the storage unit 32.

For example, in the case of the user designating the designated facility 70b on the map screen on which the map displayed on the display unit 44 is displayed, by causing all facilities 70a for which the facility visit ratio is known to be displayed on the map screen on which the map displayed on the display unit 44 of the user terminal 40 is displayed, the customer visit number calculation unit 314 can confirm which facility 70a is located in a predetermined region of the designated facility 70b or on the same road as the designated facility 70b.

The customer visit number calculation unit 314, in the case of the facility 70a for which the moving body visit ratio was calculated being present in a predetermined ratio designated for the designated facility 70b or on the same road as the designated facility 70b, for example, can calculate (predict) the customer visit number (customer entering number and customer leaving number) for the designated facility 70b, based on the moving body visit ratio (moving body entering ratio and moving body leaving ratio) of the facility 70a for every predetermined time slot on a given day and the moving body visit number (moving body entering number and moving body leaving number) for the designated facility 70b, for example.

### <Functional Blocks Equipped to User Terminal 40>

Since it is possible to realize the user terminal 40 by a general personal computer, a detailed explanation will be omitted. As shown in FIG. 6, the user terminal 40 is configured to at least include a control unit 41, storage unit 42, communication unit 43, display unit 44, and input 45. The configuration of each part, for example, is respectively similar to the configuration of each part having the same name of the onboard navigation device 10 or mobile terminal 20.

The control unit 41 includes a customer visit number query unit 411. The customer visit number query unit 411 enables access by user ID assigned to person having authority to reference customer data of the facility 70a, for example, to the information analysis device 30. The customer visit number query unit 411, in the case of any facility 70b (=facility 70b for which visiting customer data is unknown to this user) being designated from among the facilities 70 included in the map information 321 by the user, requests to the information analysis device 30 so as to calculate a virtual customer visit number of the designated facility 70b. By configuring in this way, it is possible to query the virtual customer visit number (virtual customer entering number and virtual customer leaving number) by predetermined time slots on a given day of the week for the designated facility 70b. By configuring in this way, it is made easy for the user to plan a partnership with another facility 70b or sales promotional activities (campaigns) with visitors to the other facility 70b as a target, for example, so that the customers visiting another facility 70b will visit this facility, for example.

### <Operation of Present Embodiment>

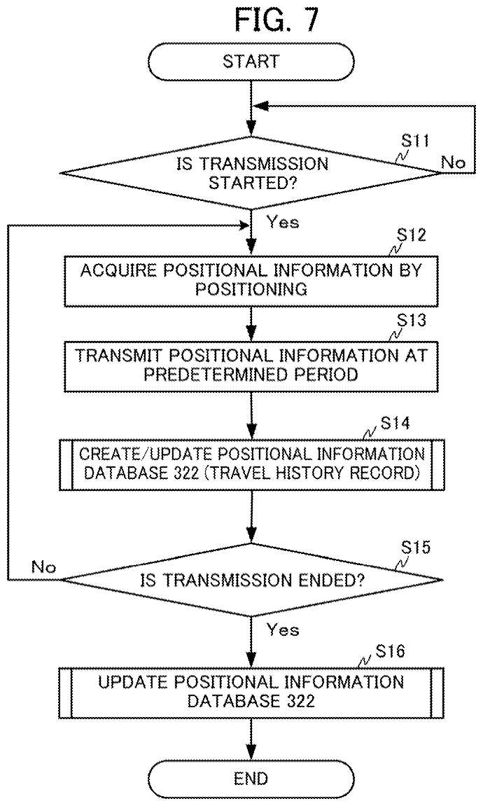

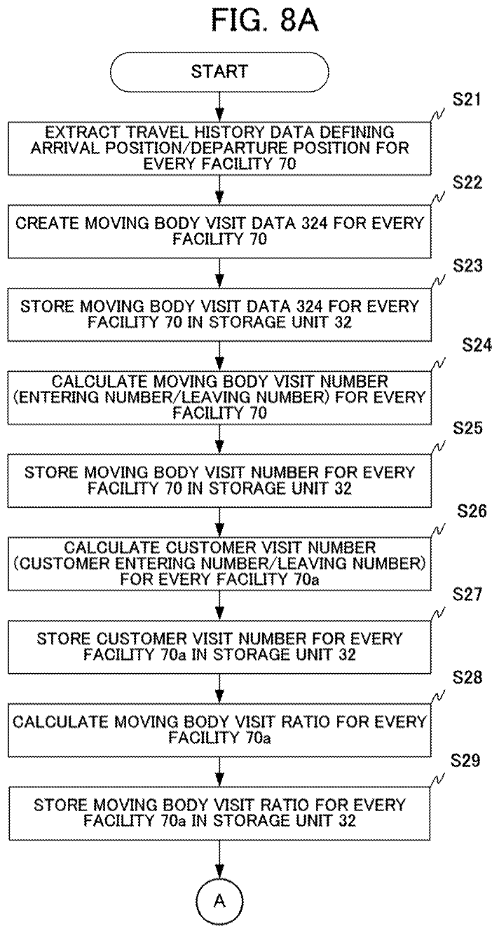

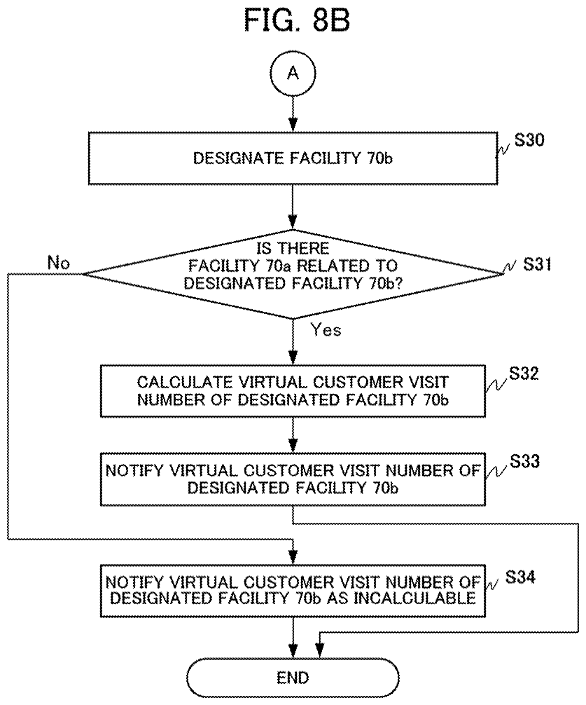

Next, the operation of the present embodiment will be explained by referencing the flowcharts of FIGS. 7 and 8. Herein, FIG. 7 is a flowchart showing the operation during collection of positional information and update of the visit information database 322. In addition, FIGS. 8A and 8B are flowcharts showing basic operation of predicting virtual customer visit number.

First, operation during collection of positional information for the onboard navigation device 10, and creation and update of the positional information database 322 will be explained by referencing FIG. 7. In Step S11, it is determined whether the positional information transmission unit 112 starts transmission of the positional information. Herein, as mentioned above, transmission is started in a case of the ignition switch of the vehicle 60a being turned ON. In the case of the ignition switch being left OFF (NO in Step S11), transmission by the positional information transmission unit 112 is not started. On the other hand, in the case of the ignition switch being turned ON (YES in Step S11), the processing advances to Step S12.

In Step S12, the sensor unit 14 acquires positional information by measuring the position of the onboard navigation device 10. In Step S13, the positional information transmission unit 112 acquires positional information from the sensor unit 14, and does real-time transmission or burst transmission of the acquired positional information at predetermined periods to the information analysis device 30.

In Step S14, the positional information database update unit 311 of the information analysis device 30 creates and updates the travel history record of the positional information database 322, based on the positional information transmitted in Step S13.

In Step S15, it is determined whether the positional information transmission unit 112 ends transmission of the positional information. As mentioned above, in the case of the ignition switch of the vehicle 60a being turned OFF, the transmission comes to an end. In the case of the ignition switch of the vehicle 60a being left ON (NO in Step S15), the positioning of Step S12 and the transmission of Step S13, and the update/creation of the travel history record of the positional information database 322 in Step S14 are repeated.

On the other hand, in the case of the ignition switch of the vehicle 60a being turned OFF (YES in Step S15), the processing advances to Step S16.

In Step S16, the positional information database update unit 311 of the information analysis device 30 updates the positional information database 322 (visited facility), by determining the arrival position (visited facility) in this travel history record according to the transmission end of positional information. According to the above explained operation, the collection of positional information and the creation and update of the positional information database 322 are realized.

Next, operations during the collection of positional information for the mobile terminal 20 and the update of positional information database 322 will be explained. In the above explanation for the mobile terminal 20, the positional information transmission unit 112 may be replaced with the positional information transmission unit 212, the sensor unit 14 may be replaced with the sensor unit 24, the reference of being YES in Step S11 may be replaced with “case of start switch of the vehicle 60b such as the ignition switch being turned ON and the vehicle 60b and mobile terminal 20 pairing”, and the reference of being YES in Step 14 may be replaced with “case of start switch of the vehicle 60b such as the ignition switch being turned OFF, and the pairing between the vehicle 60b and mobile terminal 20 being released”. Therefore, redundant explanations are omitted.

Next, the flowchart showing the base operation of predicting the virtual customer visit number of the facility 70b will be explained by referencing the flowcharts of FIGS. 8A and 8B.

When referencing FIG. 8A, in Step S21, the moving body visit determination unit 312 extracts from the positional information database 322 all of the travel history records for which the departure position in the departure positional information of the moving body and arrival position in the arrival positional information match with the position of the facility 70 within a predetermined period set in advance for every facility 70 included in the map information 321.

In Step 22, the moving body visit determination unit 312 creates moving body visit data 324 of the facility 70 based on the arrival time in the arrival positional information and the departure time in the departure positional information of the travel history record of the moving body extracted in Step S21 for every facility 70.

In Step S23, the moving body visit determination unit 312 causes the moving body visit data 324 within a predetermined period to be stored in the storage unit 32 for every facility 70.

In Step S24, the moving body visit ratio calculation unit 313 calculates the number of moving bodies having entered the facility 70 (moving body entering number) or the number of moving bodies having left the facility 70 (moving body leaving number) for every predetermined time slot on a given day of the week, based on the moving body visit data 324 stored for every facility 70.

In Step S25, the moving body visit ratio calculation unit 313 causes the moving body visit number (moving body entering number and moving body leaving number) of the facility 70 calculated for every predetermined time slot on a given day of the week in Step S24 to be stored in the storage unit 32.

In Step S26, the moving body visit ratio calculation unit 313 calculates the customer number entering the facility 70a (customer entering number or customer number leaving the facility 70a (customer leaving number) for every predetermined time base on a given day of the week, based on the customer visit data 323 stored for every facility 70a.

In Step S27, the moving body visit ratio calculation unit 313 causes the customer visit number (customer entering number and customer leaving number) for the facility 70a calculated for every predetermined time slot on a given day of the week in Step S26 to be stored in the storage unit 32.

In Step S28, the moving body visit ratio calculation unit 313 calculates in advance for every predetermined time slot on a given day of the week the moving body visit ratio (moving body entering ratio and moving body leaving ratio) for the facility 70a, based on the moving body visit number (moving body entering number and moving body leaving number) of the facility 70a calculated for every predetermined time slot on a given day of the week stored in Step S25 for every facility 70a, and the moving body visit ratio (moving body entering number and moving body leaving number) of the facility 70a calculated for every predetermined time slot on a given day of the week stored in Step S27.

In Step S29, the moving body visit ratio calculation unit 313 causes the moving body visit ratio (moving body entering ratio and moving body leaving ratio) of the facility 70a calculated for every predetermined time slot on a given day of the week in Step S28 to be stored in the storage unit 32.

When referencing FIG. 8B, in the customer visit number calculation unit 314, any facility 70b is designated from among the facilities 70 included in the map information 321 by the user in Step S30.

In Step S31, the customer visit number calculation unit 314 searches for the facility 70a for which the moving body visit ratio was calculated within a predetermined region satisfying the condition set in advance relative to the facility 70b, or on the same road as the designated facility 70b. In the case of the facility 70a being searched (YES), the processing advances to Step S32. In the case of the facility 70a not being searched (NO), the processing advances to Step S34.

In Step S32, the customer visit number calculation unit 314 calculates a virtual customer visit number for the facility 70b in a predetermined time slot on a given day of the week, based on the moving body visit ratio of the facility 70a.

In Step S33, the customer visit number calculation unit 314 notifies the virtual customer visit number of the facility 70b in the predetermined time slot on a given day of the week of the facility 70a calculated in Step S32. Thereafter, the processing comes to an end.

In Step S34, the customer visit number calculation unit 314 notifies to the user that the virtual customer visit number of the facility 70b could not be calculated. Thereafter, the processing comes to an end.

According to the operation of the present embodiment explained above, it is possible to predict the customer visit number coming to another facility 70b in a predetermined time slot on a given day of the week from the vehicle number coming to the other facility 70b by vehicle in the predetermined time slot on the given day of the week, based on the proportion of the vehicle number coming to a certain facility 70a by vehicle in a predetermined time slot on a given day of the week and the customer visit number coming to this facility 70a in the predetermined time slot on the given day of the week.

### <Regarding Hardware and Software>

It should be noted that each of the respective devices included in the above-mentioned navigation system can be realized by hardware, software, or a combination thereof. In addition, the navigation method performed by each of the respective devices included in the above-mentioned navigation system cooperating can also be realized by hardware, software or a combination of these. Herein, being realized by software indicates the matter of being realized by a computer reading and executing a program.

The program can be stored using various types of non-transitory computer readable media, and supplied to the computer. Non-transitory computer readable medium includes various types of tangible storage media. Examples of non-transitory computer readable media include magnetic recording media (e.g., flexible disk, magnetic tape, hard disk drive), magneto-optical recording media (e.g., magneto-optical disk), CD-ROM (Read Only Memory), CD-R, CD-R/W and semiconductor memory (e.g., mask ROM, PROM (programmable ROM), EPROM (Erasable PROM), flash ROM, RAM (random access memory)). In addition, the program may be supplied to the computer by way of various types of transitory computer readable media. Examples of transitory computer readable media include electrical signals, optical signals and electromagnetic waves. Transitory computer readable media can supply programs to the computer via wired communication paths such as electric wires and optical fiber, or wireless communication paths.

### Modified Examples

The aforementioned embodiment is a preferred embodiment of the present invention; however, it is not to limit the scope of the present invention to only the above embodiment, and implementation in modes arrived at by conducting various modifications in a range not departing from the gist of the present invention is possible.

For example, the functional configurations of FIGS. 2, 3, 4 and 6 are merely exemplifications, and are not to limit the functional configuration of the present embodiment. In other words, it is sufficient if the functions which can be execute a series of processing related to the information analysis function of the present invention as a whole are equipped to each device, and what kind of functional block is used in order to realize this function is not particularly limited to the examples of FIGS. 2, 3, 4 and 6.

In addition, as another modified example, the onboard navigation device 10 and mobile terminal 20 may be realized by another device not having a route guidance function. In other words, the route guidance function by the onboard navigation device 10 or mobile terminal 20 is not an essential configuration. In this case, the information analysis device 30 further includes a route guidance function, and the information analysis device 30 may be configured so as to perform route guidance by performing communication with the onboard navigation device 10 or mobile terminal 20.

Furthermore, as another modified example, although the aforementioned embodiment is explained as realizing the information analysis device 30 by one server device or the like, it may be established as a distributed processing system which distributes each function of the information analysis device 30 to a plurality of server devices as appropriate. Moreover, it may realize each function of the information analysis device 30 using a virtual server function or the like on a cloud.

For example, in the aforementioned embodiment, the information analysis device 30 is made a configuration which receives from each vehicle 60 the identification information of this vehicle 60, positional information, time information, etc. via the communication nit 33. Furthermore, the positional information database update unit 311 is made a configuration which constructs the positional information database 322 based on the identification information, positional information, time information, etc. received from each vehicle 60, and creates and updates as appropriate. In contrast, it may be configured so as to provide an FCD (Floating Car Data) server (provisional name), for example, separately from the information analysis device 30, and the FCD server receives from each vehicle 60 the identification information, positional information, time information, etc. of these vehicles 60. In this case, the information analysis device 30 may be configured so as to acquire the positional information, etc. of each vehicle from the FCD server. Furthermore, it may be configured so that the FCD server receives from each vehicle 60 the identification information, positional information, time information, etc. of these vehicles 60, constructs the positional information database 322, and creates/updates as appropriate. In this case, the information analysis device 30 may be configured so as to appropriately acquire information stored in the positional information database 322 from the FCD server.

Furthermore, as another modified example, functions as the user terminal 40 may be equipped to the information analysis device 30. In other words, it may be configured to provide the display unit 35 and input unit 36 (not shown) to the information analysis device 30, accept designation of the designated facility 70b from the user on the input unit 36 of the information analysis device 30, and display the virtual customer visit number (virtual customer entering number and virtual customer leaving number) for predetermined time slots on a given day of the week for the designated facility 70b on the display unit 35 of the information analysis device 30. In addition, by causing a known analysis tool to be executed by the information analysis device 30, it is possible to classify facilities with similar moving body visit ratios, by analyzing (for example, clustering) the moving body facility ratios by time slots on days of the week.

### EXPLANATION OF REFERENCE NUMERALS

1 information analysis system
10 onboard navigation device
11, 21, 31, 41 control unit
111, 211 route guidance unit
112, 212 positional information transmission unit
12, 22, 32, 42 storage unit
121, 221 positional information
122, 222 identification information
13, 23, 33, 43 communication unit
14, 24 sensor unit
15, 25, 44 display unit
16, 26, 45 input unit
20 mobile terminal
27 near field communication unit
30 information analysis device
311 positional information database update unit
312 moving body visit determination unit
313 moving body visit ratio calculation unit
314 customer visit number calculation unit
321 map information
322 positional information database
323 customer visit data
324 moving body visit data
325 customer management data
40 user terminal
411 customer visit number query unit
50 communication network
60, 60a, 60b vehicle
70, 70a, 70b facility

1. An information analysis device comprising:
a reception unit which receives positional information of a plurality of moving bodies;
a map information storage unit which stores map information including roads on which the plurality of moving bodies can travel, and positions of a plurality of facilities to which the plurality of moving bodies can visit;
a visit data storage unit which stores customer visit data related to visits of customers to at least any one facility among the plurality of facilities;
a moving body visit determination unit which determines visits of the plurality of moving bodies to the facility based on positional information of the plurality of moving bodies and a position of the facility stored in the customer visit data, and stores moving body visit data of the plurality of moving bodies to the facility;
a moving body visit ratio calculation unit which calculates a moving body visit ratio which is a ratio of a moving body visit number and a customer visit number for the facility, according to a comparison between the customer visit data and the moving body visit data for the facility; and
a customer visit number calculation unit which, in a case of a facility stored in the customer visit data being present in a predetermined region set in advance corresponding to a designated facility that was arbitrarily designated from among the plurality of facilities, or on a road which is the same as the designated facility, calculates a virtual customer visit number to the designated facility, based on a moving body visit ratio to the facility calculated by the moving body visit ratio calculation unit.

2. The information analysis device according to claim 1,
wherein the customer visit data is stored for every predetermined time slot of one day, and
wherein the customer visit number calculation unit calculates the customer visit number visiting the designated facility for every predetermined time slot of one day.

3. An information analysis method performed by a computer equipped with a map information storage unit which stores map information including roads on which a plurality of moving bodies can travel, and positions of a plurality of facilities to which the plurality of moving bodies can visit, and a visit data storage unit which stores customer visit data related to visits of customers to at least any one facility among the plurality of facilities, the method comprising the steps of:
receiving positional information of the plurality of moving bodies;
determining visits of the plurality of moving bodies to the facility based on positional information of the plurality of moving bodies and the position of the facility stored in the customer visit data, and storing moving body visit data of the plurality of moving bodies to the facility;
calculating a moving body visit ratio which is a ratio of a moving body visit number and a customer visit number to the facility, according to a comparison between the customer visit data and the moving body visit data of the facility; and
calculating, in a case of a facility stored in the customer visit data being present in a predetermined region set in advance corresponding to a designated facility that was arbitrarily designated from among the plurality of facilities, or on a road which is the same as the designated facility, a virtual customer visit number to the designated facility, based on a moving body visit ratio to the facility calculated in the step of calculating a moving body visit ratio.
